(19) United States
(12) Patent Application Publication
(10) Pub. No.: US 2003/0209074 A1
(43) Pub. Date: Nov. 13, 2003

(54) Multi-axis G sensor

(76) Inventor: Stephen Anthony George Ruff, Buckinghamshire (GB)

Correspondence Address: FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 10/396,741

(22) Filed: Mar. 25, 2003

(30) Foreign Application Priority Data
Mar. 25, 2002 (GB) 0207030.8

(51) Int. Cl. G01P 15/02

(52) U.S. Cl. 73/514.01

(57) ABSTRACT

An acceleration or deceleration sensor for locking a payout aircrew harness system comprises a frame or housing in which is received a heavy ball accommodated between opposing shells having opposing conical recesses receiving the ball. The shells are held against the ball by respective opposing springs whereby the ball and shells, in the absence of accelerating or decelerating forces are held in a balanced, equilibrium, position between the shells. The shells are carried at respective ends of respective levers or arms pivoted in the frame or housing, whereby movement of the ball in any direction relative to said frame or housing will cause pivotal movement of the arms. The sensor includes a trigger or trip mechanism of which one said arm forms part. Thus said a trigger or trip mechanism is operable by movement of said heavy ball relative to said frame or housing, to move from a sensing position to a locked position in which it will remain until a positive re-setting operation is carried out.

THIS INVENTION relates to a mechanism for sensing sudden deceleration or acceleration. The invention is of particular, but not exclusive, utility in relation to such a mechanism for use in connection with a seat belt arrangement, for example for aircrew in aircraft.

There are various systems available on the market for restraining occupants in helicopter or other aircraft seating, namely fixed harness systems and payout harness systems.

Fixed harness systems are fixed directly to the seat or vehicle structure, and are limited in that they offer no option for the occupant to move freely in his sitting position. If the occupant wants to bend forward for example, he cannot do so without loosening the adjustment straps of the harness to allow movement. This jeopardizes his safety and adjustment may be difficult or dangerous if the occupant is at the controls of a vehicle.

Payout harness systems allow the occupant of a seat to move under normal conditions by allowing ‘payout’ of webbing from an inertia reel which is attached to the seat or vehicle structure. Such systems are, of course, commonly found in automobiles.

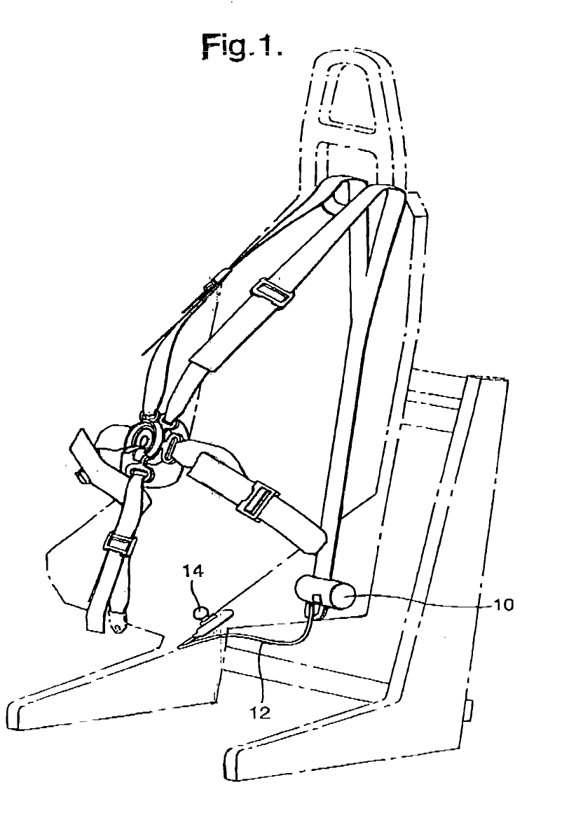

One of the most common types of inertia reel used on the payout harness system is of the two mode type. FIG. 1 shows a prior art system incorporating such an inertia reel. The mode of operation of this type is selected by a two position lock/release handle 14 that sets the mode of the inertia reel 10 via a connection cable 12. With the handle 14 in one of two positions, the webbing is prevented from paying out from the inertia reel, but can be retracted onto the reel. With the handle 14 selected in the other position, the inertia reel arrangement operates in sensing mode. In this mode, when gentle movements are made by the harness occupant, webbing will payout or retract into the inertia reel. If the occupant encounters a violent forward movement, the webbing will start to payout from the inertia reel. The inertia reel senses this acceleration of the webbing which causes a locking mechanism within the reel to ‘lock’ the webbing, preventing any more payout of the webbing from the reel. With such a two-mode system, a certain amount of webbing will payout before the inertia reel locks. If there is even a small amount of webbing payout before the inertia reel locks, this will increase the risk of the occupant suffering injury by coming into contact with objects within the cockpit environment, or will apply increased loading to the occupant at the harness contact points. Clearly this is not a desirable. One solution to this problem would be to replace the inertia reel with a more sophisticated inertia reel that has the capability of sensing both webbing acceleration and vehicle acceleration. However, such a system can be prohibitively expensive and unduly heavy.

It is an object of the present invention to provide a simple and reliable alternative solution to the above problem.

According to the invention there is provided an acceleration or deceleration sensor comprising a mass supported by resilient means relative to a frame or housing, and a trigger or trip mechanism operable by movement of said mass relative to said frame or housing, to move from a sensing position to a locked position in which it will remain until a positive re-setting operation is carried out.

In the accompanying drawings:

FIG. 1 is a perspective view, partly in phantom, of an aircraft seat with a payout harness system of the prior art;

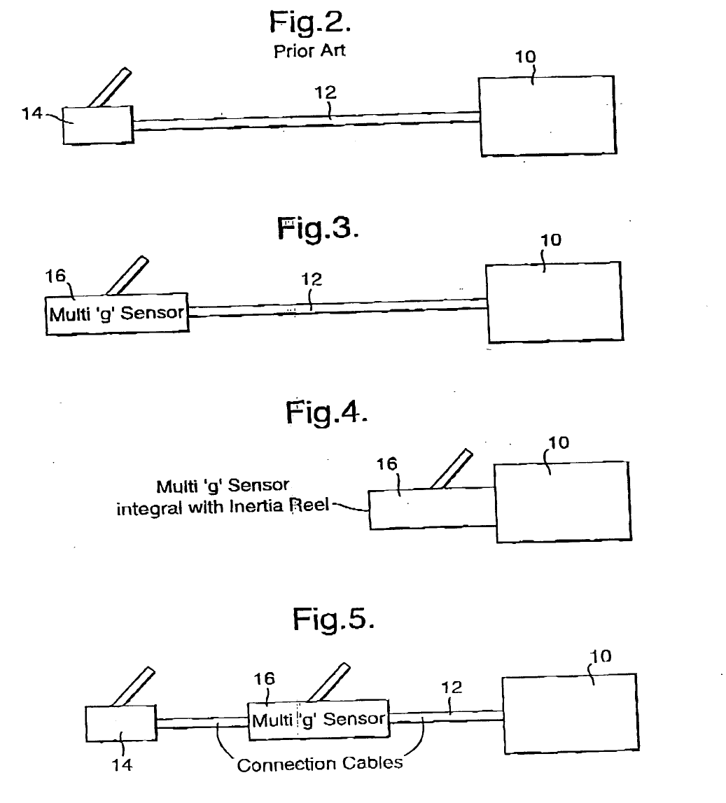

FIGS. 2, 3, 4 and 5 are diagrammatic views illustrating, in FIG. 2, a conventional two-mode payout harness system and in FIGS. 3, 4 and 5 a payout harness system embodying the invention;

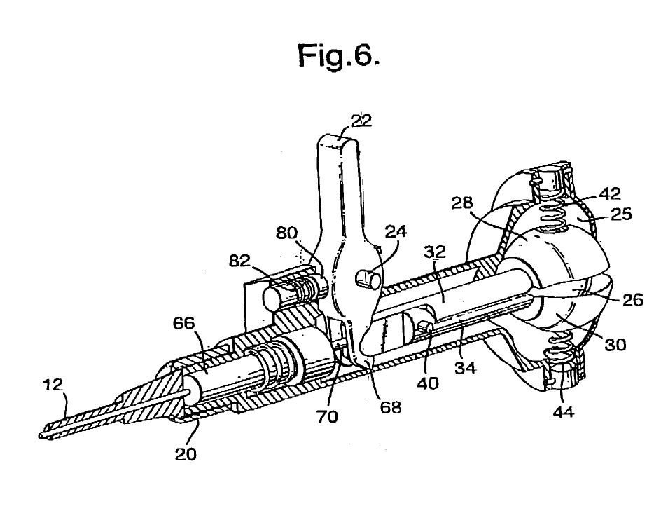

FIG. 6 is a cut-away perspective view of an acceleration/deceleration sensor embodying the invention and which can be used in the payout harness systems of FIGS. 2 to 5;

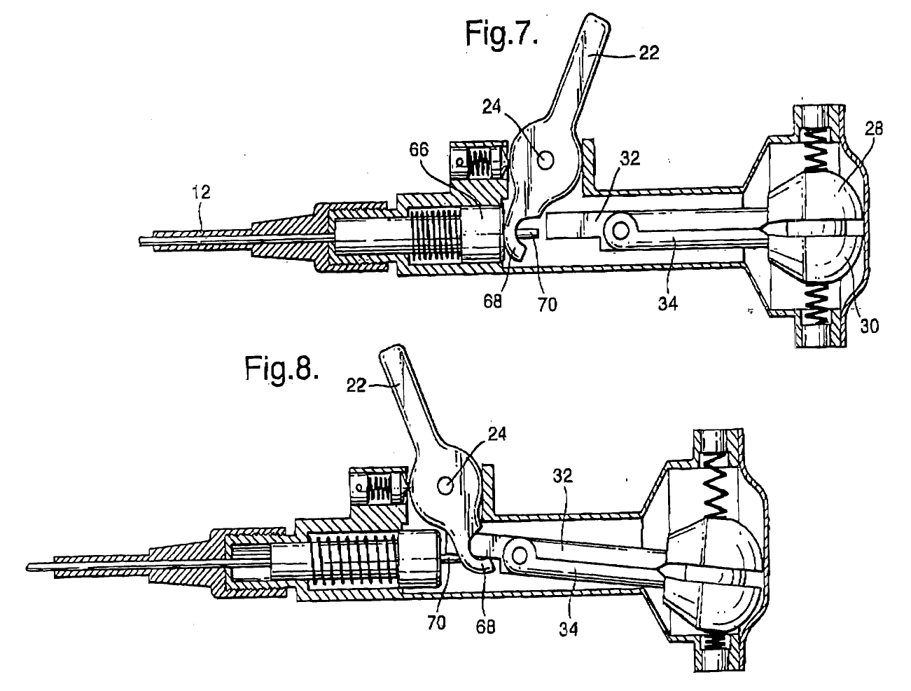

FIGS. 7, 8 and 9 are schematic views in vertical, longitudinal section through the sensor of FIG. 6;

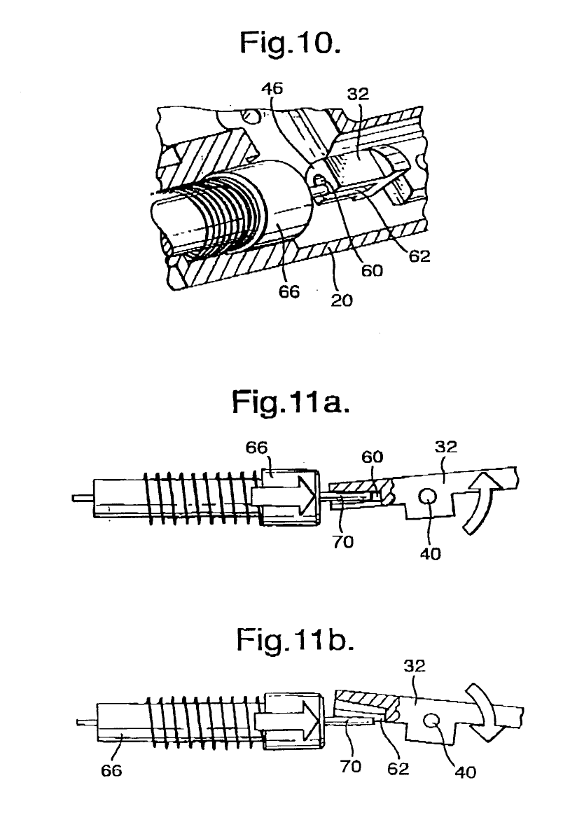

FIG. 10 is a detail perspective view, partly in section, illustrating part of the apparatus of FIGS. 6 to 9;

FIGS. 11a and 11b are schematic side elevation views of part of the apparatus of FIGS. 6 to 10 in different positions thereof; and

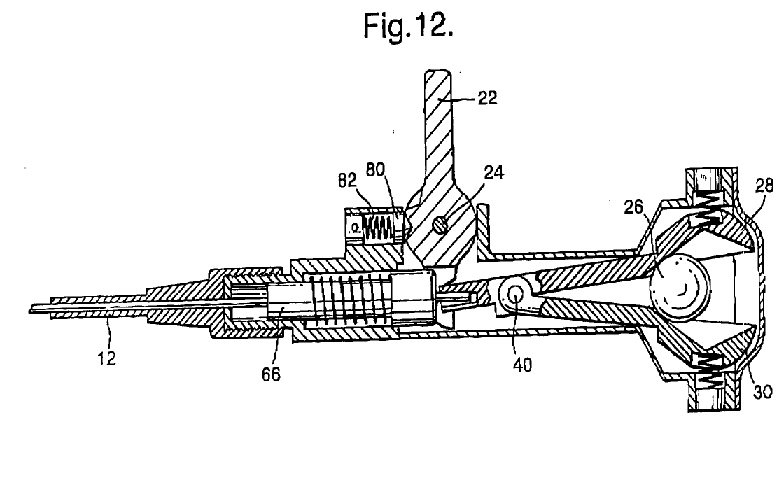

FIG. 12 is a view in vertical longitudinal section, similar to FIGS. 7 to 9, further illustrating operation of the system.

With reference to the drawings, there is illustrated a sensor mechanism which is suitable for incorporation in an air crew seating harness, which is sensitive to accelerations or decelerations acting in various directions and which is capable of being fitted in existing payout harness systems and which is furthermore cost efficient and can be made light in weight. Thus, FIG. 2 illustrates schematically a known two-mode payout harness system of the type referred to above. In this system, the known inertia reel mechanism 10 is connected by a cable 12 to a mechanism incorporating a two-position lock/release handle 14. As shown in FIG. 3, an acceleration/deceleration sensor 16 may be substituted for the conventional lock/release handle 14. Alternatively, as illustrated in FIG. 4, the acceleration/deceleration sensor 16 may be mounted directly on the inertia reel mechanism 10 without any intervening cable. As a further possibility, shown in FIG. 5, the acceleration/deceleration sensor 16 may be provided in addition to the conventional lock/release handle 14 with both being, for example, connected to the inertia reel mechanism by cable 12 and arranged to operate in the event of sudden acceleration or deceleration when the conventional lock/release handle 14 is in its “release” position.

Referring to FIG. 6, this shows in cut-away perspective view the acceleration/deceleration sensor 16 in an embodiment adapted to be connected by Bowden-type cable 12 to the inertia reel mechanism (not shown).

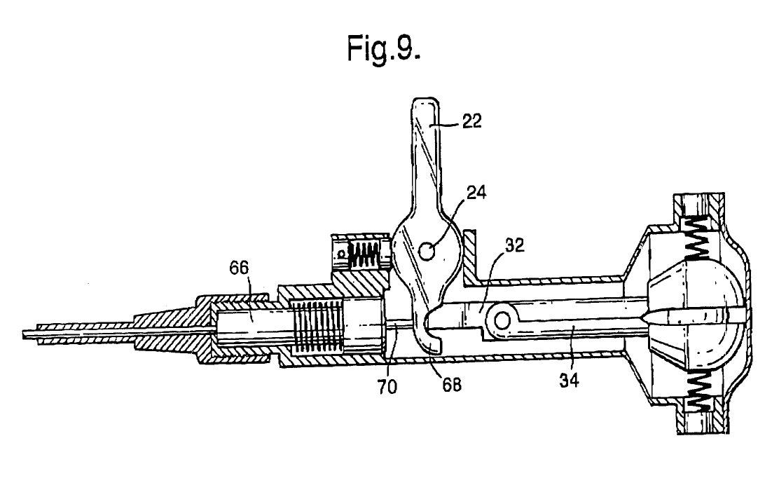

Referring to FIG. 6, the acceleration/deceleration sensor comprises a housing 20 adapted to be mounted within the aircraft structure and which housing, in turn, mounts the other elements of the acceleration/deceleration sensor. The acceleration/deceleration sensor includes an operating lever 22 which extends from housing 20 and which can be pivoted about a pivot 24 to enable the operator to select any one of three positions, namely a reset position as shown in FIG. 7, a locked position as shown in FIG. 8 and a sensing or set position as shown in FIG. 9. The operating lever 22 may be acted upon by a spring which returns the lever 22 to the set position from the reset position once band pressure on the lever 22 is removed.

The housing 20 accommodates, at one end, in a chamber 25, a heavy alloy ball 26, the function of which is to provide a motive force to lock the inertia reel in the event that the aircraft, and thus the housing, is subjected to a high acceleration or deceleration.

The ball 26 is located between two shell members 28 and 30 respectively carried at the rear ends of upper and lower arms 32, 34 respectively. Each shell 28, 30, may be externally part-spherical and each has a respective conical recess receiving a respective part of the heavy alloy ball 26. The two arms 32, 34, can pivot about a common pivot 40 in the housing for swinging in a vertical plane. Restoring springs 42 and 44 act on the upper and lower shell members to hold the latter, with the ball 26 therebetween, in an intermediate position in the chamber 25 of the housing, in the absence accelerative or decelerative forces. When any imbalance is caused between the heavy alloy ball and the restraining springs 42, 44 as a result of acceleration or deceleration forces, the lever arm 32 is caused to swing vertically, either by force applied upwardly by ball 26 on shell 28, or by spring 42 as a result of a downward movement of the ball 26 allowing spring 42 to move shell 28 downwardly, or as a result of shells 28 and 30 being forced apart by a lateral force of ball 26 against the conical surfaces of the recesses in the shells, in which the ball 26 therefore acts with a wedging action between the shells. The last-noted position is shown in FIG. 12.

The upper arm 32, at its end remote from ball 26, terminates in an end face 46 (see FIG. 10) into which extend two bores 60, 62 which extend radially with respect to the axis of pivot 40 and are somewhat spaced apart angularly so that the openings formed where these bores open onto the end face 46 are spaced apart to define a portion of the end face 46 as a land interposed between these openings.

The housing 20 accommodates, in an end region thereof remote from the ball 26, a generally cylindrical plunger 66 which is slidable along an axis of the housing within a complementary cylindrical bore in the housing. In the arrangement shown, the plunger 66 includes a smaller diameter axially extending portion or pin 70 neater the ball 20 and a larger diameter portion received in said cylindrical bore. A biasing spring 68 located within said larger part of said cylinder acts on the larger diameter part of the plunger 66 to urge the latter rearwardly, i.e. in a direction towards the ball 26. In the intermediate or “at rest” condition of the ball 26 and arms 32, 34, the latter extend substantially along said axis, whilst the pivot 40 is intersected by that axis. The inner part of the Bowden cable 12 is fixed to the plunger 66 and likewise extends substantially along said axis. In the sensing position of the apparatus, pin 70 bears against the land between the two openings provided by bores 60, 62, whereby the plunger 66 is held in the forward position with the biasing spring 68 compressed. When the upper arm 32 is pivoted upwardly or downwardly the free end of pin 70 slides over the land or end surface of lever 32 between bores 60 and 62 until the pin 70 becomes aligned with one or other of these bores 60, 62, allowing the plunger 66 to be moved rearwardly by the biasing spring 68 as the pin 70 enters the respective bore 60 or 62, (as illustrated in FIGS. 10a or 10b), whereby the Bowden cable inner is drawn rearwardly relative to the Bowden cable outer in order to lock the inertia reel. The pin 70 in co-operation with the arm 32, bores 60, 62 and end face land therebetween thus form a trigger or catch arrangement or trip mechanism which will pass from its sensing state to its locked state when actuated by high acceleration or deceleration.

Referring to FIG. 6 the lever 22 carries, at its lower end, within the housing 20, downwardly depending legs 68 which straddle the pin 70 of plunger 66 and are spaced apart sufficiently to allow free movement of pin 70 but are sufficiently close to engage the adjoining end face, within the housing 20, of the larger diameter part of the plunger 66 when the lever 22 is pivoted into the reset position shown in FIG. 7. Thus movement of the lever 22 into the reset position shown in FIG. 7 causes the legs 68 to push the plunger 66 to the left in FIG. 7, withdrawing the pin 70 of the plunger 66 from the respective bore 60, 62 so that the springs 42, 44 can return the shells 28, 30 and arms 32, 34 to their intermediate, balanced position in which the land on the end face of arm 32 between the bores 60, 62 is directly opposite the free end of the pin 70. To assist movement of the plunger 66 to the reset position in this way, the edges of the legs 68 nearer the end face of the larger diameter part of plunger 66 are curved to afford a camming action when the lever 22 is moved to the reset position. After such restoration of the levers 32, 34 to their intermediate position, the lever 22 can be returned or is returned automatically by a spring to its position shown in FIG. 9. The lower, free ends of the legs 68 of the lever 22 are connected by a cross-piece which, when the lever 22 is moved towards the locked position shown in FIG. 8, engages the underside of the part of the arm 32 which projects beyond the arm 34 towards the plunger 66 and this cross-piece thereby forces the arm 32 and with it the ball 26 and arm 34, to swing clockwise as viewed in FIG. 8 allowing pin 70 to enter the bore 62. Thus, movement of the lever 22 towards the locked position has the same effect as an upward acceleration of the sensor housing 20 relative to the ball 26 does, when the sensor is in the sensing position. Thus, placing the lever 22 in the locked position prevents any payout of webbing from the inertia reel.

It will be appreciated that many variants of the arrangement shown are possible. For example, instead of a pin 70 on spring loaded plunger 66 bearing slidingly on a land between bores 60, 62 in an end surface of arm 32, arm 32 might carry a pin or projection which can slide over a smooth end surface of plunger 66 until it drops into one or other of two recesses in such end face. Indeed as the function of the bores 60, 62 is simply to provide spaces into which the element, such as pin 70 can drop after sliding along the surface between these, almost any form of recess or cut away will serve in place of bores 60, 62. By way of illustration, the bore 62 is shown cut-away longitudinally in the drawings so that it is merely a groove rather than a bore.

As shown in FIG. 12, the housing 20 carries a detent plunger 80 which is biased by a detent spring 82 towards the central portion of lever 22, along a line of action which ideally passes through or close to the pivotal axis 24 of lever 22. The detent 80 has a conical nose which is engageable in a selective one of two recesses formed in an arcuate external surface of the middle part of the lever 22, thereby to retain the lever 22 against minor, e.g. accelerative/decelerative or vibrational forces, in its sensing position shown in FIG. 9 when the detent is engaged in one of the these recesses, or in its locked position as shown in FIG. 8, when the detent is engaged in the other of these recesses. However, the spring 82 and the displaceable nature of the detent 80 allow displacement of the detent from such recess when tie lever 22 is moved positively by the occupant, e.g. towards the re-set or towards the locked position.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention on diverse forms thereof.

1. An acceleration or deceleration sensor comprising a mass supported by resilient means relative to a frame or housing, and a trigger or trip mechanism operable by movement of said mass relative to said frame or housing, to move from a sensing position to a locked position in which it will remain until a positive re-setting operation is carried out.

2. A sensor according to claim 1 wherein said trigger or trip mechanism includes a first member including a surface terminating in an edge, for example an edge of a bore or recess extending into said surface, the mechanism further including a second member for engaging said surface, biasing means, means mounting said first and second member for movement by said mass in such a way as to cause sliding movement of said second member along said surface of the first member until said second member passes said edge, resilient biasing means urging at least one of said first member and said second member relative to the other so as to tend to maintain said second member in sliding contact with said surface of said first member, and for causing displacement of said first member relative to said second member, or displacement of said second member relative to said first member, after said second member passes said edge.

3. An acceleration or deceleration sensor according to claim 2, wherein said mass is a heavy ball accommodated between opposing shells having opposing conical recesses receiving said ball and being held against said ball by respective opposing springs whereby the ball and shells, in the absence of accelerating or decelerating forces are held in a balanced, equilibrium, position between said shells, said shells being carried at respective ends of respective levers or arms pivoted in said frame or housing, whereby movement of the ball in any direction relative to said frame or housing will cause pivotal movement of said arms and wherein one said arm forms said first member or said second member of said trigger or trip mechanism.

4. A sensor according to claim 2 in combination with a pay-out harness system, wherein said second member and said biasing means therefor together form an actuator which locks the pay-out harness system when said second member passes said edge.
